(19) United States
(12) Patent Application Publication
(10) Pub. No.: US 2025/0391866 A1
(43) Pub. Date: Dec. 25, 2025

(54) SECONDARY BATTERY AND PREPARATION METHOD, DISPERSANT, AND ELECTRIC APPARATUS

(71) Applicant: CONTEMPORARY AMPEREX TECHNOLOGY (HONG KONG) LIMITED, Hong Kong (CN)

(72) Inventors: Yanying WU, Ningde (CN); Cheng CHENG, Ningde (CN); Jichun HUANG, Ningde (CN)

(21) Appl. No.: 18/949,748

(22) Filed: Nov. 15, 2024

(30) Foreign Application Priority Data
Jun. 20, 2024 (CN) 202410804421.3

(51) Int. Cl. H01M 4/62; C09D 5/24; C09D 7/45; C09D 7/62; C09D 7/65; C09D 127/16; H01M 4/02; H01M 4/58

(52) U.S. Cl. CPC H01M 4/62; C09D 5/24; C09D 7/45; C09D 7/62; C09D 7/65; C09D 127/16; H01M 2004/028; H01M 4/5825

(57) ABSTRACT

A secondary battery includes a housing, and a cell assembly and an electrolyte that are disposed in the housing. The cell assembly includes a negative electrode plate, a separator, and a positive electrode plate that are sequentially stacked. The positive electrode plate includes a positive electrode current collector and a positive electrode active layer. The positive electrode active layer is disposed on at least one side of the positive electrode current collector. The positive electrode active layer includes a positive electrode active material and a dispersant. The dispersant is a polymer including an anchoring group and a siloxane segment, where the anchoring group includes a polar heteroatom-containing group and/or a derivative thereof.

### CROSS-REFERENCE TO RELATED APPLICATION

This application claims priority to Chinese Application No. 202410804421.3, filed on Jun. 20, 2024, the entire content of which is incorporated herein by reference.

### TECHNICAL FIELD

This application relates to the field of battery technologies, specifically to a secondary battery and a preparation method, a dispersant, and an electric apparatus.

### BACKGROUND

Lithium-ion batteries, due to their high output voltage, large energy density, high power density, long cycle life, and good environmental friendliness, are widely used in electronic consumer products, energy storage, traction power, and other fields. As technologies in the field of battery application continue to develop, the requirements for the energy density of lithium-ion batteries continuously increase.

A lithium-ion battery includes a positive electrode plate; the positive electrode plate includes a positive electrode current collector and a positive electrode active layer disposed on at least one side of the positive electrode current collector; and the positive electrode active layer includes a positive electrode active material. The positive electrode active layer is typically formed by applying a slurry onto the surface of the positive electrode current collector, and the dispersion effect of the positive electrode active material in the slurry affects the performance of the battery.

### SUMMARY

This application provides a secondary battery and a preparation method, a dispersant, and an electric apparatus to improve the dispersiveness of a positive electrode active material.

To resolve the foregoing technical problem, this application provides a first technical solution: A secondary battery is provided, and the secondary battery at least includes a housing, and a cell assembly and an electrolyte that are disposed in the housing. The cell assembly includes a negative electrode plate, a separator, and a positive electrode plate that are sequentially stacked. The positive electrode plate includes a positive electrode current collector and a positive electrode active layer. The positive electrode active layer is disposed on at least one side of the positive electrode current collector. The positive electrode active layer includes a positive electrode active material and a dispersant. The dispersant is a polymer including an anchoring group and a siloxane segment, where the anchoring group includes a polar heteroatom-containing group and/or a derivative thereof.

The anchoring group of the dispersant provided in the embodiments of this application is used to act on the particle surface of the polar positive electrode active material, forming an electric layer structure on the particle surface. The surfaces of the particles have the same electrical property, generating electrostatic repulsion between the particles, reducing aggregation and sedimentation between particles, and promoting stable dispersion of the positive electrode active material in the slurry. Using the above dispersant improves the dispersion effect of the positive electrode active material in the slurry, allowing the positive electrode active material to be more evenly distributed in the slurry. This helps to form a uniform conductive network, making the current distribution more uniform during charge and discharge, thereby improving the efficiency and stability of the secondary battery.

In addition, the silicon-oxygen bond rotation barrier of the siloxane segment of the dispersant is low, making the dispersant polymer tend to be linear, reducing the intermolecular slip resistance, and increasing the flexibility. A film layer formed by applying the slurry prepared from this dispersant has good flexibility, alleviating the issue of the electrode plate being prone to cracking under thick coating and high pressure, thereby enhancing the stability of the secondary battery.

In an embodiment, the positive electrode active material includes a phosphate containing lithium transition metal.

The dispersant provided in the embodiments of this application has a good and stable dispersion effect on the phosphate containing lithium transition metal, thereby improving the efficiency and stability of the secondary battery.

In an embodiment, a surface of the phosphate containing lithium transition metal is coated with carbon.

In the embodiments of this application, the surface of the phosphate containing lithium transition metal is coated with carbon, significantly increasing the charge transfer efficiency between the phosphate particles containing lithium transition metal, and improving conductivity, which is conducive to improving the efficiency of the secondary battery.

In an embodiment, the mass percentage of the dispersant in relation to the positive electrode active material is 0.2%-5%.

In the embodiments of this application, the dispersant of the above percentage is used to disperse the positive electrode active material, achieving a good dispersion effect in a case of a high solid content. The positive electrode active layer formed by applying the positive electrode active slurry with a high solid content is relatively thin, which is conducive to reducing the resistance of the electrode plate and reducing the internal resistance of the battery, thus improving the efficiency and stability of the secondary battery.

In an embodiment, the polar heteroatom-containing group and/or the derivative thereof includes at least one of a carboxyl group and a derivative thereof, a sulfonic acid group and a derivative thereof, and a phosphoric acid group and a derivative thereof; and the carboxyl group and the derivative thereof include —O—Cn-COOR₀₁, the sulfonic acid group and the derivative thereof include —O—Cn-SO₃R₀₂, and the phosphoric acid group and a derivative thereof include

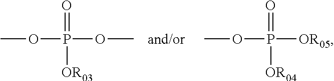

where Cn represents an alkane carbon chain, and 1≤n≤12; and R₀₁, R₀₂, R₀₃, R₀₄, and R₀₅ are each independently selected from at least one of H, C1-C12 alkyl, C1-C12 alkyl alcohol, or C1-C12 alkyl hydroxylamine.

In the embodiments of this application, the above groups are used as anchoring groups, which adsorb onto the particle surface of the positive electrode active material, forming an electric layer structure on the particle surface. This generates electrostatic repulsion between the particles, achieving stable dispersion of the positive electrode active material in the slurry, thereby improving the efficiency and stability of the secondary battery.

In an embodiment, the siloxane segment includes a silicon-oxygen bond and a branched segment connected to a silicon atom, and the branched segment includes at least one of a C1-C12 carbon chain and a polyether segment.

The silicon atoms of the siloxane segment provided in the embodiments of this application are connected to branched segments, which can provide a strong steric hindrance effect. Using the dispersant provided in the embodiments of this application on the particle surface of the positive electrode active material can alleviate the re-aggregation of particles during the dispersion process, further maintaining the stable dispersion of the positive electrode active material in the slurry, thereby enhancing the efficiency and stability of the secondary battery.

In an embodiment, a structural formula of the dispersant is:

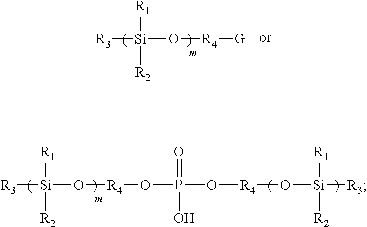

where G represents the anchoring group; R₁ and R₂ are each independently selected from at least one of a C1-C12 carbon chain and a polyether segment; R₃ and R₄ are each independently selected from at least one of a carbon chain, a polyether segment, a polyester amide segment, an alkoxy segment,

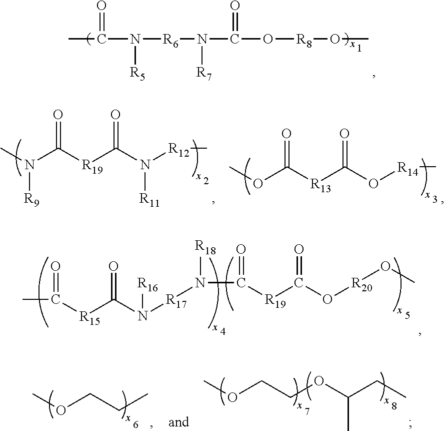

R₅ and R₂₀ are each independently selected from at least one of an alkane carbon chain and a benzene ring; and x₁=1-20, x₂=1-20, x₃=1-20, x₄=1-20, x₅=1-20, x₆=1-40, x₇=1-40, x₈=1-25, and m is 1-100.

The dispersant provided in the embodiments of this application further includes R₃ and R₄, R₃, R₄, and the siloxane segment form a solvation segment, and the solvation segment can fully extend in the solvent, providing a strong steric hindrance effect. This can alleviate the re-aggregation of particles during the dispersion process, maintaining the stable dispersion of the positive electrode active material in the slurry, thereby enhancing the efficiency and stability of the secondary battery.

In an embodiment, at least one of R₃ and R₄ includes a heteroatom, and the heteroatom includes at least one of O and N.

In the embodiments of this application, at least one of R₃ and R₄ includes a heteroatom. The heteroatom itself has a certain polarization adsorption ability, and can adsorb residues on the particle surface of the positive electrode active material via hydrogen bonds, improving the coverage of the particle surface of the positive electrode active material, thereby enhancing the efficiency and stability of the secondary battery.

In an embodiment, the weight average molecular weight of the dispersant is 500 g/mol-50000 g/mol.

When the dispersant provided in the embodiments of this application has the above weight average molecular weight, the dispersant has good solubility. The dispersant has good coverage on the particle surface of the positive electrode active material, achieving a good dispersion effect. The volume of the dispersant is appropriate, providing a large steric hindrance, alleviating the re-aggregation of particles during the dispersion process, and maintaining the stable dispersion of the positive electrode active material in the slurry, thereby enhancing the efficiency and stability of the secondary battery.

To resolve the foregoing technical problems, this application provides a second technical solution: A preparation method of a secondary battery is provided, at least including: sequentially stacking a negative electrode plate, a separator, and a positive electrode plate to form a cell assembly, where a preparation method of the positive electrode plate includes: obtaining a positive electrode current collector; and applying a positive electrode active slurry to at least one side of the positive electrode current collector to form a positive electrode active layer; where the positive electrode active slurry includes a positive electrode active material and a dispersant, the dispersant is a polymer including an anchoring group and a siloxane segment, and the anchoring group includes a polar heteroatom-containing group and/or a derivative thereof; placing the cell assembly in a housing; and injecting an electrolyte into the housing.

The preparation method of a secondary battery provided in the embodiments of this application can be used to prepare the secondary battery provided in the above embodiment, at least having the same advantages as the above secondary battery.

In an implementation, a solid content of the positive electrode active slurry is greater than or equal to 59%; and/or a viscosity of the positive electrode active slurry is 4000 mPa·s-30000 mPa·s; and/or a mass percentage of the dispersant in relation to the positive electrode active material is 0.2%-5%; and the dispersant accounts for 0.01%-3% of a total mass of the positive electrode active slurry.

Based on the positive electrode active slurry provided in the embodiments of this application, the dispersant with a high solid content achieves a good dispersion effect. The positive electrode active layer formed by applying the positive electrode active slurry with a high solid content is relatively thin, which is conducive to reducing the resistance of the electrode plate and reducing the internal resistance of the battery, thus improving the efficiency and stability of the secondary battery.

To resolve the foregoing technical problems, this application provides a third technical solution: A dispersant is provided, and the dispersant is a polymer including an anchoring group and a siloxane segment, and the anchoring group includes a polar heteroatom-containing group and/or a derivative thereof.

The anchoring group of the dispersant provided in the embodiments of this application is used to act on the particle surface of the polar positive electrode active material, forming an electric layer structure on the particle surface. The surfaces of the particles have the same electrical property, generating electrostatic repulsion between the particles, reducing aggregation and sedimentation between particles, and promoting stable dispersion of the positive electrode active material in the slurry. In addition, the silicon-oxygen bond rotation barrier of the siloxane segment of the dispersant is low, making the dispersant polymer tend to be linear, reducing the intermolecular slip resistance, and increasing the flexibility, such that a film layer formed by applying the slurry prepared from this dispersant has good flexibility. Applying the dispersant provided in this application to the positive electrode active layer of the secondary battery is conducive to improving the efficiency and stability of the secondary battery.

In an embodiment, the polar heteroatom-containing group and/or the derivative thereof includes at least one of a carboxyl group and a derivative thereof, a sulfonic acid group and a derivative thereof, and a phosphoric acid group and a derivative thereof; and the carboxyl group and the derivative thereof include —O—Cn-COOR₀₁, the sulfonic acid group and the derivative thereof include —O—Cn-SO₃R₀₂, and the phosphoric acid group and a derivative thereof include

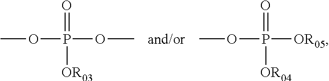

where Cn represents an alkane carbon chain, and 1≤n≤12; and R₀₁, R₀₂, R₀₃, R₀₄, and R₀₅ are each independently selected from at least one of H, C1-C12 alkyl, C1-C12 alkyl alcohol, or C1-C12 alkyl hydroxylamine.

In the embodiments of this application, the above groups are used as anchoring groups, which adsorb onto the particle surface of the positive electrode active material, forming an electric layer structure on the particle surface. This generates electrostatic repulsion between the particles, achieving stable dispersion of the positive electrode active material in the slurry. Applying the dispersant provided in this application to the positive electrode active layer of the secondary battery is conducive to improving the efficiency and stability of the secondary battery.

In an embodiment, the siloxane segment includes a silicon-oxygen bond and a branched segment connected to a silicon atom, and the branched segment includes at least one of a C1-C12 carbon chain and a polyether segment.

The silicon atoms of the siloxane segment provided in the embodiments of this application are connected to branched segments, which can provide a strong steric hindrance effect. Using the dispersant provided in the embodiments of this application on the particle surface of the positive electrode active material can alleviate the re-aggregation of particles during the dispersion process, further maintaining the stable dispersion of the positive electrode active material in the slurry. Applying the dispersant provided in this application to the positive electrode active layer of the secondary battery is conducive to improving the efficiency and stability of the secondary battery.

In an embodiment, a structural formula of the dispersant is:

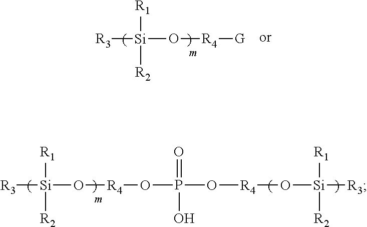

where G represents the anchoring group; R₁ and R₂ are each independently selected from at least one of a C1-C12 carbon chain and a polyether segment; R₃ and R₄ are each independently selected from at least one of a carbon chain, a polyether segment, a polyester amide segment, an alkoxy segment,

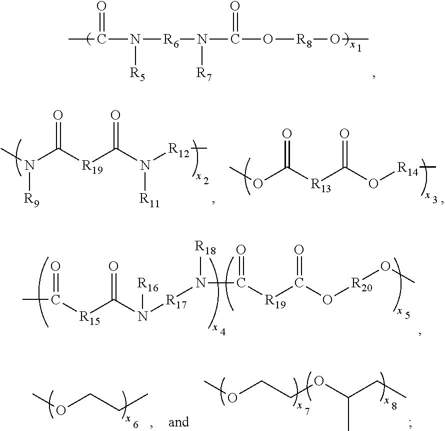

R₅ and R₂₀ are each independently selected from at least one of an alkane carbon chain and a benzene ring; and x₁=1-20, x₂=1-20, x₃=1-20, x₄=1-20, x₅=1-20, x₆=1-40, x₇=1-40, x₈=1-25, and m is 1-100.

The dispersant provided in the embodiments of this application further includes R₃ and R₄, R₃, R₄, and the siloxane segment form a solvation segment, and the solvation segment can fully extend in the solvent, providing a strong steric hindrance effect. This can alleviate the re-aggregation of particles during the dispersion process, maintaining the stable dispersion of the positive electrode active material in the slurry. Applying the dispersant provided in this application to the positive electrode active layer of the secondary battery is conducive to improving the efficiency and stability of the secondary battery.

In an embodiment, at least one of R₃ and R₄ includes a heteroatom, and the heteroatom includes at least one of O and N.

In the embodiments of this application, at least one of R₃ and R₄ includes a heteroatom. The heteroatom itself has a certain polarization adsorption ability, and can adsorb residues on the particle surface of the positive electrode active material via hydrogen bonds, improving the coverage of the particle surface of the positive electrode active material. Applying the dispersant provided in this application to the positive electrode active layer of the secondary battery is conducive to improving the efficiency and stability of the secondary battery.

In an embodiment, the weight average molecular weight of the dispersant is 500 g/mol-50000 g/mol.

When the dispersant provided in the embodiments of this application has the above weight average molecular weight, the dispersant has good solubility. The dispersant has good coverage on the particle surface of the positive electrode active material, achieving a good dispersion effect. The volume of the dispersant is appropriate, providing a large steric hindrance, alleviating the re-aggregation of particles during the dispersion process, and maintaining the stable dispersion of the positive electrode active material in the slurry. Applying the dispersant provided in this application to the positive electrode active layer of the secondary battery is conducive to improving the efficiency and stability of the secondary battery.

To resolve the foregoing technical problems, this application provides a fourth technical solution: an electric apparatus is provided, including the secondary battery according to any one of the preceding embodiments or a secondary battery prepared using the preparation method of a secondary battery of any one of the preceding embodiments. The electric apparatus at least has the same advantages as the foregoing secondary battery or a secondary battery prepared using the preparation method of a secondary battery.

### BRIEF DESCRIPTION OF DRAWINGS

To describe the technical solutions in embodiments of this application more clearly, the following briefly describes the accompanying drawings required for describing some embodiments. Apparently, the accompanying drawings in the following descriptions show merely some embodiments of this application, and persons of ordinary skill in the art may still derive other drawings from these accompanying drawings without creative efforts.

FIG. 1 is a schematic structural exploded view of a battery according to an embodiment of this application;

FIG. 2 is a schematic structural exploded view of a battery cell according to an embodiment of this application;

FIG. 3 is a schematic structural diagram of a positive electrode plate according to an embodiment of this application;

FIG. 4 is a schematic flowchart of a preparation method for a positive electrode plate in a preparation method of a secondary battery according to an embodiment of this application; and

FIG. 5 is a schematic structural diagram of an electric apparatus according to an embodiment of this application.

### DESCRIPTION OF EMBODIMENTS

The following clearly and completely describes the technical solutions in the embodiments of this application with reference to the accompanying drawings in the embodiments of this application. Apparently, the described embodiments are only some but not all of the embodiments of this application. All other embodiments obtained by persons of ordinary skill in the art based on the embodiments of this application without creative efforts shall fall within the protection scope of this application.

In the following description, specific details such as specific system structures, interfaces, and technologies are presented for illustrative purposes rather than limitation, facilitating through understanding of this application.

The terms “first,” “second,” and “third” in this application are used for descriptive purposes only and should not be understood as indicating or implying relative importance or implicitly indicating the number of the indicated technical features. Thus, features defined as “first,” “second,” and “third” may explicitly or implicitly include at least one of the features. In the description of this application, “multiple” means at least two, such as two or three, unless otherwise specifically defined. All directional indications (for example, up, down, left, right, front, and back) in the embodiments of this application are used to merely explain the relative positional relationships, movements, and the like, between the components in a specific posture (as shown in the figure). If the specific posture changes, the directional indications also change accordingly. The terms “include” and “comprise” and any variations thereof in the embodiments of this application are intended to cover non-exclusive inclusion. For example, a process, method, system, product, or device that includes a series of steps or units is not limited to the listed steps or units but optionally includes steps or units not listed, or further optionally includes other steps or components inherent to the process, method, product, or device.

In this specification, reference to “embodiment” means that specific features, structures, or characteristics described with reference to the embodiment may be included in at least one embodiment of this application. The word “embodiment” appearing in various places in this specification does not necessarily refer to the same embodiment or an independent or alternative embodiment that is exclusive of other embodiments. Persons skilled in the art explicitly and implicitly understand that the embodiments described herein may combine with another embodiment.

In this disclosure, the phrases “at least one of A, B, and C” and “at least one of A, B, or C” both mean only A, only B, only C, or any combination of A, B, and C.

This application is described in detail below with reference to the drawings and the embodiments.

As the technologies in the field of battery application continue to develop, the requirements for the energy density of the lithium-ion battery continuously increase. To increase the energy density of the lithium-ion battery, the particle size of the positive electrode active material can be reduced, and the percentage of the positive electrode active material in the slurry can be increased.

However, as the particle size of the positive electrode active material decreases, the specific surface area increases, and the surface energy increases. The attraction (for example, van der Waals force) between the particles of the positive electrode active material is enhanced, and the particles of the positive electrode active material easily aggregate into larger particles or agglomerates due to the attraction, leading to poor dispersion between the particles of the positive electrode active material.

As the percentage of the positive electrode active material in the slurry increases, the spacing between the particles of the positive electrode active material decreases, leading to stronger attraction forces (for example, van der Waals force and electrostatic force) between the particles, and making it easier for the particles to aggregate and agglomerate, thereby reducing the dispersiveness.

The poor dispersion of the positive electrode active material in the slurry reduces the uniformity of the slurry and also affects the stability of the slurry. The film layer formed by applying the slurry has an uneven thickness, affecting the performance of the battery.

Given the above situation, embodiments of this application provide a secondary battery and a preparation method, a dispersant, and an electric apparatus to improve the dispersiveness of a positive electrode active material.

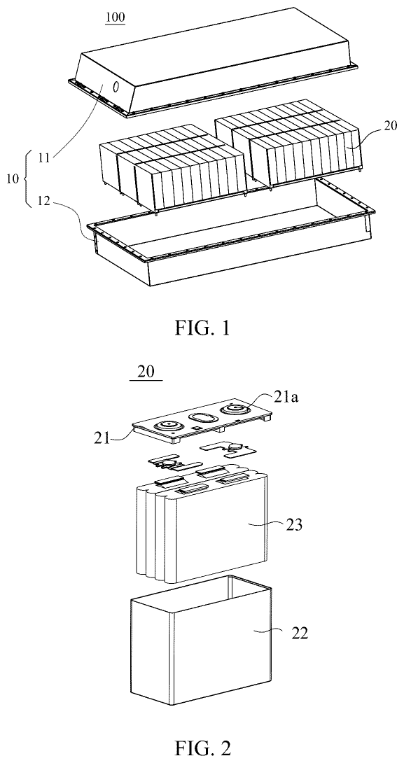

Refer to FIG. 1, which is a schematic structural exploded view of a battery according to an embodiment of this application.

The embodiments of this application further provide a battery 100, where the battery 100 includes multiple such battery cells 20. The battery 100 disclosed in the embodiments of this application can be used for electric apparatuses that use a battery as a power source or various energy storage systems that use a battery as an energy storage element.

The battery 100 includes a box 10 and a battery cell 20, where the battery cell 20 is accommodated in the box 10. The box 10 is configured to provide an accommodating space for the battery cell 20. The box 10 may be a variety of structures. In some embodiments, the box 10 may include a first portion 11 and a second portion 12. The first portion 11 and the second portion 12 fit together such that the first portion 11 and the second portion 12 jointly define a space for accommodating the battery cell 20. The second portion 12 may be a hollow structure with one end open, and the first portion 11 may be a plate structure, where the first portion 11 covers the open side of the second portion 12 so that the first portion 11 and the second portion 12 jointly define the accommodating space. Alternatively, the first portion 11 and the second portion 12 may both be hollow structures with one side open, where the open side of the first portion 11 is engaged with the open side of the second portion 12. Certainly, the box 10 formed by the first portion 11 and the second portion 12 may be of a variety of shapes, for example, cylinder or cuboid.

In the battery 100, the battery cell 20 is present in plurality, and the plurality of battery cells 20 may be connected in series, parallel, or series-parallel, where being connected in series-parallel means a combination of series and parallel connections of the plurality of battery cells 20. The plurality of battery cells 20 may be directly connected in series, parallel, or series-parallel, and then an entirety of the plurality of battery cells 20 is accommodated in the box 10. Certainly, the battery 100 may alternatively be formed in a manner that a plurality of battery cells 20 are connected in series, parallel, or series-parallel first to form a battery module and then a plurality of battery modules are connected in series, parallel, or series-parallel to form an entirety which is accommodated in the box 10. The battery 100 may further include other structures. For example, the battery 100 may further include a busbar configured to implement electrical connection between the plurality of battery cells 20.

Each battery cell 20 may be a secondary battery or a primary battery, or may be a lithium-sulfur battery, a sodium-ion battery, or a magnesium-ion battery, without being limited thereto. The battery cell 20 may be cylindrical, flat, cuboid, or of other shapes.

Refer to FIG. 2, which is a schematic structural exploded view of a battery cell according to an embodiment of this application.

The embodiments of this application also provide a battery cell 20, and the battery cell 20 refers to the smallest unit that constitutes the battery 100 described later. The battery cell 20 includes an end cover 21, a housing 22, a cell assembly 23, and other functional components.

The end cover 21 refers to a component that covers an opening of the housing 22 to isolate an internal environment of the battery cell 20 from an external environment. A shape of the end cover 21 is not limited and may be adapted to a shape of the housing 22 to fit the housing 22. Optionally, the end cover 21 may be made of a material with certain hardness and strength (for example, aluminum alloy), so that the end cover 21 is less likely to deform when subjected to extrusion and collision, allowing the battery cell 20 to have higher structural strength and enhanced safety performance. The end cover 21 may be provided with functional components such as an electrode terminal 21a. The electrode terminal 21a may be configured to electrically connect to the cell assembly 23 for outputting or inputting electric energy of the battery cell 20. In some embodiments, the end cover 21 may be further provided with a pressure relief mechanism for releasing internal pressure when the internal pressure or temperature of the battery cell 20 reaches a threshold. The end cover 21 may also be made of various materials such as copper, iron, aluminum, stainless steel, aluminum alloy, and plastic. This is not particularly limited in the embodiments of this application. In some embodiments, an insulator may also be provided at an inner side of the end cover 21. The insulator may be configured to isolate an electrically connected component in the housing 22 from the end cover 21 to reduce the risk of short circuit. For example, the insulator may be made of plastic, rubber, or the like.

The housing 22 is an assembly configured to form the internal environment of the battery cell 20 together with the end cover 21, where the formed internal environment may be configured to accommodate the cell assembly 23, an electrolyte, and other components. The housing 22 and the end cover 21 may be independent components, and an opening may be provided in the housing 22, so that the end cover 21 can close the opening to form the internal environment of the battery cell 20. Without limitation, the end cover 21 and the housing 22 may also be integrated. Specifically, the end cover 21 and the housing 22 may form a shared connection surface before other components are disposed inside the housing, and then the end cover 21 covers the housing 22 when inside of the housing 22 needs to be enclosed. The housing 22 may be of various shapes and sizes, for example, a rectangular shape, a cylindrical shape, and a hexagonal prism shape. Specifically, the shape of the housing 22 may be determined according to a specific shape and size of the cell assembly 23. The housing 22 may be made of various materials such as copper, iron, aluminum, stainless steel, aluminum alloy, and plastic. This is not particularly limited in the embodiments of this application.

The cell assembly 23 is a component in which electrochemical reactions take place in the battery cell 20. The housing 22 may include one or more cell assemblies 23. The cell assembly 23 is mainly formed by winding or stacking a positive electrode plate and a negative electrode plate, and a separator is generally provided between the positive electrode plate and the negative electrode plate. Parts of the positive electrode plate and the negative electrode plate with an active substance constitute a main body of the cell assembly, while parts of the positive electrode plate and the negative electrode plate without an active substance respectively constitute tabs. A positive electrode tab and a negative electrode tab may both be located at one end of the main body or be located at two ends of the main body respectively. During charge and discharge of the battery, a positive electrode active material and a negative electrode active material react with an electrolyte, and the tabs are connected to the electrode terminal to form a current loop.

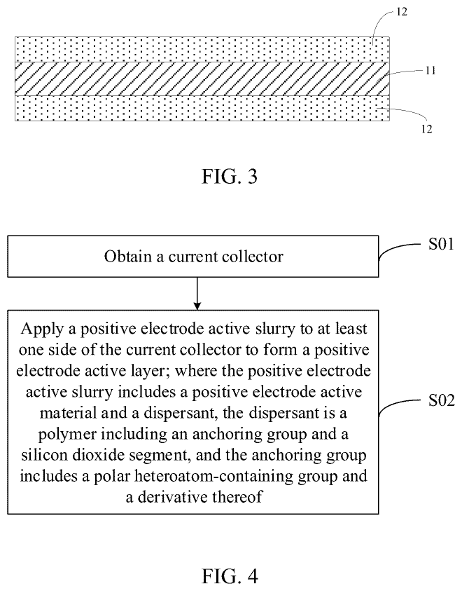

Refer to FIG. 3, which is a schematic structural diagram of a positive electrode plate according to an embodiment of this application;

The positive electrode plate includes a positive electrode current collector 11 and a positive electrode active layer 12. The positive electrode active layer 12 is disposed on at least one side of the positive electrode current collector 11, the positive electrode active layer 12 includes a positive electrode active material and a dispersant, the dispersant is a polymer including an anchoring group and a siloxane segment, and the anchoring group includes a polar heteroatom-containing group and/or a derivative thereof.

The anchoring group of the dispersant is used to act on the particle surface of the polar positive electrode active material, forming an electric layer structure on the particle surface. The surfaces of the particles have the same electrical property, generating electrostatic repulsion between the particles, reducing aggregation and sedimentation between particles, and promoting stable dispersion of the positive electrode active material in the slurry, thus improving the dispersiveness.

Using the above dispersant improves the dispersion effect of the positive electrode active material in the slurry, allowing the positive electrode active material to be more evenly distributed in the slurry. This helps to form a uniform conductive network, making the current distribution more uniform during charge and discharge, thereby improving the efficiency and stability of the secondary battery.

In addition, the silicon-oxygen bond rotation barrier of the siloxane segment of the dispersant is low, making the dispersant polymer tend to be linear, reducing the intermolecular slip resistance, and increasing the flexibility. A film layer formed by applying the slurry prepared from this dispersant has good flexibility, improving the flexibility of the electrode plate, and alleviating the issue of the electrode plate being prone to cracking under thick coating and high pressure, thereby enhancing the stability of the secondary battery.

In an embodiment, the positive electrode active material includes a phosphate containing lithium transition metal.

The dispersant provided in the embodiments of this application has a good and stable dispersion effect on the phosphate containing lithium transition metal, which is conducive to improving the battery performance, thereby improving the efficiency and stability of the secondary battery. For example, the positive electrode active material includes lithium iron phosphate (LFP).

In an embodiment, when the positive electrode active material includes a phosphate containing lithium transition metal, the surface of the phosphate containing lithium transition metal is coated with carbon.

In the embodiments of this application, the surface of the phosphate containing lithium transition metal is coated with carbon, significantly increasing the charge transfer efficiency between the phosphate particles containing lithium transition metal, and improving conductivity, which is conducive to improving the efficiency of the secondary battery. The anchoring group of the dispersant can interact with the carbon applied to the surface of the phosphate containing lithium transition metal, allowing the dispersant to adsorb on the surface of the positive electrode active material.

In an embodiment, the mass percentage of the dispersant in relation to the positive electrode active material is 0.2%-5%.

In the embodiments of this application, the dispersant of the above percentage is used to disperse the positive electrode active material, achieving a good dispersion effect in a case of a high solid content. The positive electrode active layer formed by applying the positive electrode active slurry with a high solid content is relatively thin, which is conducive to reducing the resistance of the electrode plate and reducing the internal resistance of the battery, thus improving the efficiency and stability of the secondary battery. The high solid content refers to a solid content greater than or equal to 59%. The mass percentage of the dispersant in relation to the positive electrode active material may be 0.2%, 0.5%, 1%, 1.5%, 2%, 2.5%, 3%, 3.5%, 4%, 4.5%, 5%, or in a range defined by any two of these values, for example 0.2%-3%, 1%-4%, or 2.5%-5%.

In an embodiment, the polar heteroatom-containing group and/or the derivative thereof includes at least one of a carboxyl group and a derivative thereof, a sulfonic acid group and a derivative thereof, and a phosphoric acid group and a derivative thereof; and the carboxyl group and the derivative thereof include —O—Cn-COOR₀₁, the sulfonic acid group and the derivative thereof include —O—Cn—SO₃R₀₂, and the phosphoric acid group and a derivative thereof include

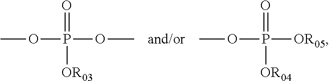

where Cn represents an alkane carbon chain, and 1≤n≤12; and R₀₁, R₀₂, R₀₃, R₀₄, and R₀₅ are each independently selected from at least one of H, C1-C12 alkyl, C1-C12 alkyl alcohol, or C1-C12 alkyl hydroxylamine.

C1-C12 alkyl refers to an alkyl group containing 1-12 carbon atoms, and specifically, the number of carbon atoms may be 1, 2, 3, 4, 5, 6, 7, 8, 9, 10, 11, 12, or in a range defined any two of these values, for example, 2-8 or 4-12. C1-C12 alkyl alcohol refers to a functional group containing a hydroxyl group connected to an alkyl chain, where the number of carbon atoms in the alkyl chain is 1-12, and specifically, the number of carbon atoms may be 1, 2, 3, 4, 5, 6, 7, 8, 9, 10, 11, 12, or in a range defined any two of these values, for example, 3-8 or 5-12. C1-C12 alkyl hydroxylamine refers to a functional group containing a hydroxylamine group connected to an alkyl chain, where the number of carbon atoms in the alkyl chain is 1-12, and specifically, the number of carbon atoms may be 1, 2, 3, 4, 5, 6, 7, 8, 9, 10, 11, 12, or in a range defined by any two of these values, for example, 1-6 or 3-12.

In the embodiments of this application, the above groups are used as anchoring groups, which adsorb onto the particle surface of the positive electrode active material, forming an electric layer structure on the particle surface. This generates electrostatic repulsion between the particles, achieving stable dispersion of the positive electrode active material in the slurry, thereby improving the efficiency and stability of the secondary battery.

The carboxyl group and the derivative thereof, and the sulfonic acid group and the derivative thereof include an alkane carbon chain (Cn). The alkane carbon chain can enhance the repulsion between particles and reduce the tight stacking and mutual association of dispersant molecules, which is conducive to improving the adsorption coverage rate of the dispersant on the surface of the positive electrode active material, and maintaining a good dispersion state of the positive electrode active material in the slurry.

R₀₁, R₀₂, R₀₃, R₀₄, and R₀₅ are each independently selected from at least one of C1-C12 alkyl, C1-C12 alkyl alcohol, or C1-C12 alkyl hydroxylamine, and can regulate the adsorption capacity of the anchoring group, which is conducive to maintaining a good dispersion state of the positive electrode active material in the slurry, and enhancing the stability of the dispersion system, thereby improving the efficiency and stability of the secondary battery. It can be understood that the positive electrode active material includes a phosphate containing lithium transition metal. When the surface of the phosphate containing lithium transition metal is coated with carbon, different carbon coatings result in different polarities of the particle surface of the positive electrode active material. Specific molecular structures of R₀₁, R₀₂, R₀₃, R₀₄, and R₀₅ groups are selected based on the polarity of the surface, coated with carbon, of the phosphate containing lithium transition metal. In other words, in the design of the embodiments of this application, R₀₁, R₀₂, R₀₃, R₀₄, and R₀₅ can be independently selected from at least one of C1-C12 alkyl, C1-C12 alkyl alcohol, or C1-C12 alkyl hydroxylamine, making the dispersant provided by the embodiments of this application suitable for different phosphates containing lithium transition metal, thereby expanding the applicability range. C1-C12 alkyl alcohol includes a heteroatom O, or C1-C12 alkyl hydroxylamine includes heteroatoms O and N, which can form hydrogen bonds, specifically adsorbing the carbon-coated residues on the particle surface of the positive electrode active material, where the residues may be hydroxyl, carboxyl, and other functional groups containing hydrogen bonds. This helps to enhance the adsorption capacity of the anchoring group on the particles of the positive electrode active material.

In an embodiment, the siloxane segment includes a silicon-oxygen bond and a branched segment connected to a silicon atom, and the branched segment includes at least one of a C1-C12 carbon chain and a polyether segment.

C1-C12 carbon chain includes at least one of a C1-C12 alkane carbon chain and a C1-C12 benzene ring-containing carbon chain. C1-C12 carbon chain refers to an alkyl group containing 1 to 12 carbon atoms, and specifically, the number of carbon atoms may be 1, 2, 3, 4, 5, 6, 7, 8, 9, 10, 11, 12, or in a range defined by any two of these values, for example, 4-10 or 6-12. The polyether segment includes at least one of alkyl ether, aryl ether, polyoxyethylene ether, and cosegment of polyoxyethylene ether and polyoxypropylene ether.

The silicon atoms of the siloxane segment provided in the embodiments of this application are connected to branched segments, which can provide a strong steric hindrance effect. Using the dispersant provided in the embodiments of this application on the particle surface of the positive electrode active material can alleviate the re-aggregation of particles during the dispersion process, further maintaining the stable dispersion of the positive electrode active material in the slurry, thereby enhancing the efficiency and stability of the secondary battery. Additionally, the carbon chain and the polyether segment of the branched segment have good flexibility, and can be embedded into the binder polyvinylidene fluoride (PVDF) chain of the slurry, increasing the sliding ability of the PVDF chain. A film layer formed by applying the slurry prepared from this dispersant has good flexibility, improving the flexibility of the electrode plate.

In an embodiment, a structural formula of the dispersant is:

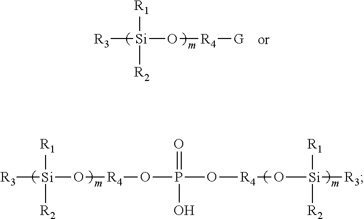

where G represents the anchoring group; R₁ and R₂ are each independently selected from at least one of a C1-C12 carbon chain and a polyether segment; R₃ and R₄ are each independently selected from at least one of a carbon chain, a polyether segment, a polyester amide segment, an alkoxy segment,

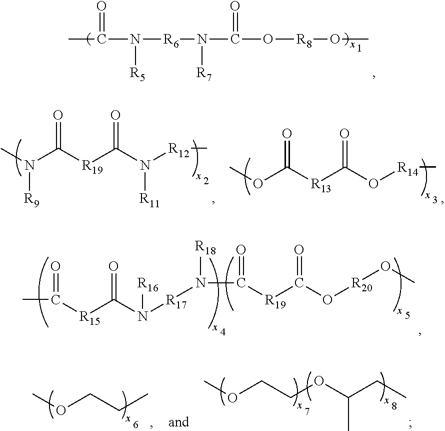

R₅ and R₂₀ are each independently selected from at least one of an alkane carbon chain and a benzene ring; and x₁=1-20, x₂=1-20, x₃=1-20, x₄=1-20, x₅=1-20, x₆=1-40, x₇=1-40, x₈=1-25, and m is 1-100.

It should be noted that G represents the anchoring group mentioned above; and R₁ and R₂ represent the branched segments connected to the silicon atoms mentioned above. When R₁ and R₂ are each independently selected from the C1-C12 carbon chain, the C1-C12 carbon chain includes at least one of a C1-C12 alkane carbon chain and a C1-C12 benzene ring-containing carbon chain. When R₁ and R₂ are each independently selected from the polyether segment, the polyether segment includes at least one of alkyl ether, aryl ether, polyoxyethylene ether, and cosegment of polyoxyethylene ether and polyoxypropylene ether. When R₃ and R₄ are each independently selected from the carbon chain, the carbon chain includes at least one of an alkane carbon chain and a benzene ring-containing carbon chain. When R₃ and R₄ are each independently selected from the polyether segment, the polyether segment includes at least one of alkyl ether, aryl ether, polyoxyethylene ether, and cosegment of polyoxyethylene ether and polyoxypropylene ether.

m may be 1, 10, 20, 30, 40, 50, 60, 70, 80, 90, 100, or in a range defined by any two of these values, for example, 1-50, 20-80 or 50-100.

The dispersant provided in the embodiments of this application further includes R₃ and R₄, R₃, R₄, and the siloxane segment form a solvation segment, and the solvation segment can fully extend in the solvent, providing a strong steric hindrance effect. This can alleviate the re-aggregation of particles of the positive electrode active material during the dispersion process, maintaining the stable dispersion of the positive electrode active material in the slurry, thereby enhancing the efficiency and stability of the secondary battery. After the slurry is stirred, the particles of the positive electrode active material can also be stably dispersed, reducing the probability of gel formation.

When the structural formula of the dispersant is

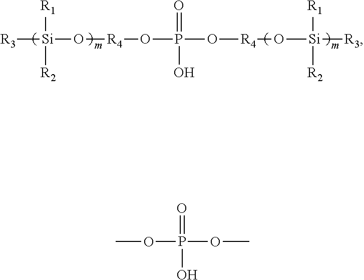

in the structural formula can adsorb onto the particle surface of the positive electrode active material, and the other segments can fully extend in the solvent, providing a strong steric hindrance effect. This can alleviate the re-aggregation of particles of the positive electrode active material during the dispersion process, maintaining the stable dispersion of the positive electrode active material in the slurry, thereby enhancing the efficiency and stability of the secondary battery.

The structural formula, with each group part selected as above, of the dispersant provided by the embodiments of this application allows the dispersant to be compatible with different surface morphologies of the positive electrode active material, improving the compatibility of the dispersant with the positive electrode active material.

In an embodiment, at least one of R₃ and R₄ includes a heteroatom, and the heteroatom includes at least one of O and N.

In the embodiments of this application, at least one of R₃ and R₄ includes a heteroatom. The heteroatom itself has a certain polarization adsorption ability, and can adsorb residues on the particle surface of the positive electrode active material via hydrogen bonds, improving the coverage of the particle surface of the positive electrode active material, thereby enhancing the efficiency and stability of the secondary battery. The residues on the particle surface of the positive electrode active material refer to the residues of the coating carbon of the particle surface of the positive electrode active material, which may be hydroxyl, carboxyl, and other functional groups containing hydrogen bonds.

In an embodiment, the weight average molecular weight of the dispersant is 500 g/mol-50000 g/mol.

When the dispersant provided in the embodiments of this application has the above weight average molecular weight, the dispersant has good solubility. The dispersant has good coverage on the particle surface of the positive electrode active material, achieving a good dispersion effect. The volume of the dispersant is appropriate, providing a large steric hindrance, alleviating the re-aggregation of particles during the dispersion process, and maintaining the stable dispersion of the positive electrode active material in the slurry, thereby enhancing the efficiency and stability of the secondary battery. The weight average molecular weight of the dispersant may be 500, 1000, 5000, 10000, 15000, 20000, 25000, 30000, 35000, 40000, 45000, 50000, or in a range defined by any two of these values, for example, 500-30000 or 10000-45000.

The embodiments of this application also provide a preparation method for a polymer with the anchoring group G of the dispersant as a carboxyl group and the terminal R₃ end-capped with methyl (for example, methoxy). The method is specifically as follows:

A hydrolytic polycondensation method is used first. Substituted dihydroxy siloxane is used as the raw material, reacts in deionized water under an alkaline condition at 25° C. for 2 h, and then is directly evaporated to be dry, to obtain a corresponding polysiloxane product:

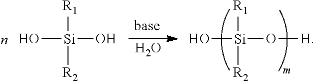

The hydroxyl group at an end of the polysiloxane product, under the catalysis of triethylamine, reacts with iodomethane in a solvent of DCM (dichloromethane) at room temperature for 2 h. The polysiloxane product is excessive and after reaction, washed with water, extracted, and evaporated to dryness to directly obtain a methoxy-capped polysiloxane product:

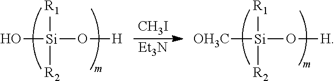

The methoxy-capped polysiloxane product, under the catalysis of triethylamine, reacts with a halogenated hydrocarbon of carboxyl containing an anchoring group in a solvent of DCM at room temperature for 24 h. After the reaction, the resulting product is washed with water, extracted, evaporated to dryness, and purified using a thin-layer chromatography column, to obtain a polysiloxane product of carboxyl containing an anchoring group:

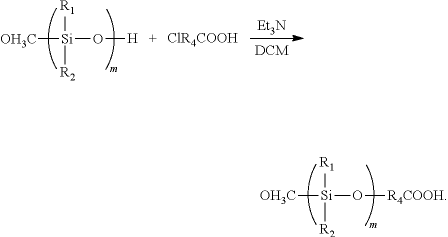

It should be noted that the specific choices of R₁, R₂, and R₄ in the preparation method provided in the above embodiment can be referred to in the aforementioned content and are not reiterated here.

In some embodiments, the positive electrode current collector 11 may be a metal foil current collector or a composite positive electrode current collector. For example, an aluminum foil may be used as the metal foil. The composite positive electrode current collector may include a polymer material substrate and a metal layer formed on at least one surface of the polymer material substrate. The composite positive electrode current collector may be formed by forming a metal material (aluminum, aluminum alloy, nickel, nickel alloy, titanium, titanium alloy, silver, silver alloy, or the like) on the polymer material matrix (for example, matrices of polypropylene (PP), polyethylene terephthalate (PET), polybutylene terephthalate (PBT), polystyrene (PS), and polyethylene (PE)).

In some embodiments, the positive electrode active layer 12 further optionally includes a binder. The binder may include at least one of polyvinylidene fluoride (PVDF), polytetrafluoroethylene (PTFE), vinylidene fluoride-tetrafluoroethylene-propylene terpolymer, vinylidene fluoride-hexafluoropropylene-tetrafluoroethylene terpolymer, tetrafluoroethylene-hexafluoropropylene copolymer, and fluorine-containing acrylic resin.

In some embodiments, the positive electrode active layer 12 further optionally includes a conductive agent. For example, the conductive agent may include at least one of superconducting carbon, acetylene black, carbon black, Ketjen black, carbon dots, carbon nanotubes, graphene, and carbon nanofiber.

In some embodiments, the positive electrode plate may be prepared in the following manner: the constituents used for preparing the positive electrode plate, for example, the positive electrode active material, the conductive agent, the binder, the dispersant, and any other constituent, are dispersed in a solvent to form a positive electrode slurry; and the positive electrode slurry is applied onto the positive electrode current collector 11, followed by processes such as drying and cold pressing to obtain the positive electrode plate. In a specific embodiment, lithium iron phosphate, conductive carbon black, polyvinylidene fluoride, dispersant, and any other components are dispersed in the solvent N-methylpyrrolidone to obtain a positive electrode slurry.

The negative electrode plate provided in the embodiments of this application includes a negative electrode current collector and a negative electrode active layer disposed on at least one surface of the negative electrode current collector, and the negative electrode active layer includes a negative electrode active material.

For example, the negative electrode current collector includes two opposite surfaces in its thickness direction, and the negative electrode active layer is disposed on either or both of the two opposite surfaces of the negative electrode current collector.

In some embodiments, the negative electrode current collector may be a metal foil or a composite negative electrode current collector. For example, the metal foil may be a copper foil. The composite negative electrode current collector may include a polymer material substrate and a metal layer formed on at least one surface of the polymer material substrate. The composite negative electrode current collector may be formed by forming a metal material (copper, copper alloy, nickel, nickel alloy, titanium, titanium alloy, silver, silver alloy, or the like) on the polymer material matrix (for example, matrices of polypropylene (PP), polyethylene terephthalate (PET), polybutylene terephthalate (PBT), polystyrene (PS), and polyethylene (PE)).

In some embodiments, the negative electrode active material may be a well-known negative electrode active material used for batteries in the art. For example, the negative electrode active material may include at least one of the following materials: artificial graphite, natural graphite, soft carbon, hard carbon, a silicon-based material, a tin-based material, lithium titanate, and the like. The silicon-based material may be selected from at least one of elemental silicon, silicon-oxygen compound, silicon-carbon composite, silicon-nitrogen composite, and silicon alloy. The tin-based material may be selected from at least one of elemental tin, tin-oxygen compound, and tin alloy. However, this application is not limited to these materials, but may use other conventional materials that can be used as negative electrode active materials for batteries instead. One of these negative electrode active materials may be used alone, or two or more of them may be used in combination.

In some embodiments, the negative electrode active layer further optionally includes a binder. The binder may be selected from at least one of styrene-butadiene rubber (SBR), polyacrylic acid (PAA), polyacrylic acid sodium (PAAS), polyacrylamide (PAM), polyvinyl alcohol (PVA), sodium alginate (SA), polymethacrylic acid (PMAA), and carboxymethyl chitosan (CMCS).

In some embodiments, the negative electrode active layer further optionally includes a conductive agent. The conductive agent may be selected from at least one of superconducting carbon, acetylene black, carbon black, Ketjen black, carbon dots, carbon nanotubes, graphene, and carbon nanofiber.

In some embodiments, the negative electrode active layer further optionally includes other promoters such as a thickener (for example, sodium carboxymethyl cellulose (CMC-Na)).

The cell assembly 23 further includes a separator. There is no particular limitation on the type of the separator in this application, and any known porous-structure separator with good chemical stability and mechanical stability can be selected.

In some embodiments, a material of the separator may be at least one selected from glass fiber, non-woven fabric, polyethylene, polypropylene, and polyvinylidene fluoride. The separator may be a single-layer film or a multi-layer composite film and is not particularly limited. When the separator is a multi-layer composite film, all layers may be made of the same or different materials, which is not particularly limited.

In some embodiments, the positive electrode plate, the negative electrode plate, and the separator may be made into a cell assembly 23 through winding or stacking.

The cell assembly 23 also includes an electrolyte. The electrolyte mainly includes an electrolytic salt and a solvent. The electrolytic salt may be selected from at least one of lithium hexafluorophosphate, lithium tetrafluoroborate, lithium perchlorate, lithium hexafluoroborate, lithium bisfluorosulfonyl imide, lithium bis-trifluoromethanesulfon imide, lithium trifluoromethanesulfonat, lithium difluorophosphate, lithium difluorooxalatoborate, lithium bisoxalatoborate, lithium difluorobisoxalate phosphate, and lithium tetrafluoro oxalate phosphate. The solvent may be at least one selected from ethylene carbonate, propylene carbonate, ethyl methyl carbonate, diethyl carbonate, dimethyl carbonate, dipropyl carbonate, methyl propyl carbonate, ethyl propyl carbonate, butylene carbonate, fluoroethylene carbonate, methyl formate, methyl acetate, ethyl acetate, propyl acetate, methyl propionate, ethyl propionate, propyl propionate, methyl butyrate, ethyl butyrate, 1,4-butyrolactone, sulfolane, methyl sulfonyl methane, methyl ethyl sulfone, and diethyl sulfone. For example, the additive may include a negative electrode film-forming additive or a positive electrode film-forming additive, or may include an additive capable of improving some performance of the battery, for example, an additive for improving overcharge performance of the battery, or an additive for improving high-temperature or low-temperature performance of the battery.

Refer to FIG. 4, which is a schematic flowchart of a preparation method for a positive electrode plate in a preparation method of a secondary battery according to an embodiment of this application.

The preparation method of a secondary battery provided in this embodiment of this application can be used to prepare the secondary battery provided in the above embodiments. The preparation method of a secondary battery at least specifically includes: sequentially stacking a negative electrode plate, a separator, and a positive electrode plate to form a cell assembly, where a preparation method of the positive electrode plate includes: step S01: obtaining a positive electrode current collector; and step S02: applying a positive electrode active slurry to at least one side of the positive electrode current collector to form a positive electrode active layer; where the positive electrode active slurry includes a positive electrode active material and a dispersant, the dispersant is a polymer including an anchoring group and a siloxane segment, and the anchoring group includes a polar heteroatom-containing group and/or a derivative thereof, placing the cell assembly in a housing; and injecting an electrolyte into the housing.

The preparation method of a secondary battery provided in this embodiment of this application can be used to prepare the secondary battery provided in the above embodiments, at least having the same advantages as the above secondary battery.

In an embodiment, the positive electrode current collector 11 includes an aluminum foil.

In an embodiment, the positive electrode active layer 12 is formed by applying the positive electrode active slurry with an easy-to-operate process. Optionally, the positive electrode active slurry is applied through extrusion to the positive electrode current collector 11. Optionally, the positive electrode active slurry is applied through transferring to the positive electrode current collector 11.

In an embodiment, the positive electrode active material includes a phosphate containing lithium transition metal. This has a good and stable dispersion effect on the phosphate containing lithium transition metal. For example, the positive electrode active material includes lithium iron phosphate (LFP).

In an implement, a solid content of the positive electrode active slurry is greater than or equal to 59%; and/or a viscosity of the positive electrode active slurry is 4000 mPa·s-30000 mPa·s; and/or a mass percentage of the dispersant in relation to the positive electrode active material is 0.2%-5%; and the dispersant accounts for 0.01%-3% of a total mass of the positive electrode active slurry. Optionally, the dispersant accounts for 0.03%-2% of a total mass of the positive electrode active slurry.

Based on the positive electrode active slurry provided in the embodiments of this application, the dispersant with a high solid content (that is, the solid content is greater than or equal to 59%) achieves a good dispersion effect on the positive electrode active material. The viscosity of the slurry is designed to be 4000 mPa·s-30000 mPa·s, reducing the probability of slurry stratification, the rebound of standing viscosity, and the probability of sedimentation and gelation during slow stirring. It can be understood that the positive electrode active layer 12 is formed by applying the positive electrode active slurry with a high solid content is thin, which helps to reduce the resistance of the electrode plate, thereby improving the efficiency and stability of the secondary battery.

The viscosity of the positive electrode active slurry may be 4000 mPa·s, 5000 mPa·s, 6000 mPa·s, 7000 mPa·s, 8000 mPa·s, 9000 mPa·s, 10000 mPa·s, 15000 mPa·s, 20000 mPa·s, 25000 mPa·s, 30000 mPa·s, or in a range defined by any two of these values, for example, 4000 mPa·s-10000 mPa·s, 8000 mPa·s-20000 mPa·s, 6000 mPa·s-30000 mPa·s, or 5000 mPa·s-15000 mPa·s. The mass percentage of the dispersant in relation to the positive electrode active material may be 0.2%, 0.5%, 1%, 1.5%, 2%, 2.5%, 3%, 3.5%, 4%, 4.5%, 5%, or in a range defined by any two of these values, for example, 0.2%-3%, 1%-4%, or 2.5%-5%. The percentage of the dispersant accounting for the total mass of the positive electrode active slurry may be 0.01%, 0.03%, 0.1%, 0.15%, 0.2%, 0.25%, 0.3%, 0.5%, 0.8%, 1%, 1.5%, 2%, 2.5%, 3%, or in a range defined by any two of the above values, for example, 0.03%-2%, 0.2%-2%, 1%-3%, 0.15%-3%, or 0.5%-1.5%.

It should be noted that there is a calculative relationship between the mass percentage of the dispersant in relation to the positive electrode active material, and the percentage of the dispersant in relation to the total mass of the positive electrode active slurry. Based on the percentage of the dispersant accounting for the total mass of the positive electrode active slurry, the amount of solvent, the amount of conductive agent, the amount of binder, and the amount of positive electrode active material, the mass percentage of the dispersant in relation to the positive electrode active material can be converted.

In a specific embodiment, the positive electrode active material, conductive agent, binder, dispersant, solvent, and other functional components are added to a mixing tank in a ratio and order, dispersed, and mixed to uniformity, to obtain a slurry suspension system. The slurry is applied to the positive electrode current collector 11, dried in an oven, and then cold-calendered based on the designed compaction and thickness, to obtain a positive electrode plate. For example, the positive electrode active material includes lithium iron phosphate. For example, the conductive agent includes conductive carbon black. For example, the binder includes polyvinylidene fluoride. For example, the solvent includes N-methylpyrrolidone.

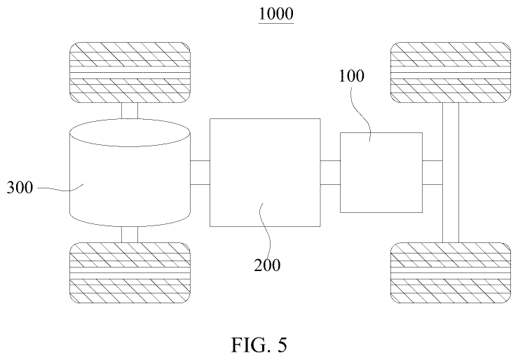

Refer to FIG. 5, which is a schematic structural diagram of an electric apparatus according to an embodiment of this application.

The embodiments of this application also provide an electric apparatus, and the electric apparatus includes the above battery. The electric apparatus may be but is not limited to a mobile phone, a tablet computer, a laptop computer, an electric toy, an electric tool, an electric bicycle, an electric vehicle, a ship, and a spacecraft. The electric toy may be a fixed or mobile electric toy, for example, a game console, an electric toy car, an electric toy ship, and an electric toy airplane. The spacecraft may include an airplane, a rocket, a space shuttle, a spaceship, and the like.

In this embodiment, the electric apparatus is a vehicle 1000. The vehicle 1000 may be a fossil fuel vehicle, a natural gas vehicle, or a new energy vehicle. The new energy vehicle may be a battery electric vehicle, a hybrid electric vehicle, a range-extended electric vehicle, or the like. The vehicle 1000 is provided with a battery 100 inside, where the battery 100 may be arranged at the bottom, front, or rear of the vehicle 1000. The battery 100 may be configured to supply power to the vehicle 1000. For example, the battery 100 may be used as an operational power supply for the vehicle 1000. The vehicle 1000 may further include a controller 200 and a motor 300, where the controller 200 is configured to control the battery 100 to supply power to the motor 300, for example, to satisfy power needs of start, navigation, and driving of the vehicle 1000.

In some embodiments of this application, the battery 100 can be used as not only the operational power supply for the vehicle 1000 but also a driving power source for the vehicle 1000, replacing or partially replacing fossil fuel or natural gas to provide driving traction for the vehicle 1000.

In this application, the performance of batteries, which are prepared from positive electrode plates provided in the examples of this application, are studied.

A preparation process in Example 1 is as follows:

### (1) Preparation of Positive Electrode Plate

(a) A positive electrode current collector aluminum foil with a thickness of 15 μm was obtained.
(b) A positive electrode active material lithium iron phosphate, a conductive agent acetylene black, a binder polyvinylidene fluoride, and a dispersant A1 were fully stirred and mixed to uniformity in a solvent N-methylpyrrolidone, to form a positive electrode active slurry. A weight ratio of lithium iron phosphate, acetylene black, and polyvinylidene fluoride was 97:2:1, and the dispersant accounted for 0.5% of a total mass of the positive electrode active slurry.
(c) The positive electrode active slurry was applied through extrusion onto the aluminum foil, dried, and cold-calendered to form a positive electrode active layer with a thickness of 200 μm, that is, a positive electrode plate.

### (2) Preparation of Negative Electrode Plate

(a) A negative electrode current collector copper foil with a thickness of 6 μm was obtained.
(b) A negative electrode active material artificial graphite, a conductive agent acetylene black, a binder styrene-butadiene rubber (SBR), and a dispersant sodium carboxymethyl cellulose (CMC) were fully stirred and mixed to uniformity in a weight ratio of 96:2:1:1 in a deionized water solvent system, to form a negative electrode active slurry.
(c) The negative electrode active slurry was applied onto the copper foil, dried, and cold-calendered to form a negative electrode active layer with a thickness of 100 μm, that is, a negative electrode plate.

### (3) Preparation of Electrolyte

Lithium salt LiPF₆ was added to a mixed solvent of ethylene carbonate (EC) and ethyl methyl carbonate (EMC) in a mass ratio of 35:65, and mixed to uniformity to obtain an electrolyte, where the molar concentration of LiPF₆ in the electrolyte was 1 mol/L.

### (4) Preparation of Separator

A 7 μm thick PE porous polymer film was used as a separator.

It should be noted that the prepared negative electrode plate, separator, and positive electrode plate were stacked in sequence, with the separator placed between the positive and negative electrode plates to provide isolation, and then wound to obtain a bare cell. The bare cell was then inserted into a housing and subjected to processes such as baking, electrolyte injection, standing, sealing, formation, and degassing, to obtain a lithium-ion battery.

Examples 2 to 11 differed from Example 1 in the morphology of the positive electrode active material, the composition of the dispersant, and the addition amount of the dispersant.

Comparative example 1 differed from Example 1 in that no dispersant was added in Comparative example 1.

Comparative example 2 differed from Example 1 in the composition of the dispersant.

The slurry viscosities in the examples and Comparative examples were the same.

The relevant parameter tests for each example and each Comparative example are as follows:

### (1) Graphitization Degree

The graphitization degree was characterized using a high-resolution Raman spectrometer from HORIBA Jobin Yvon, France, model LabRAM HR Evolution, and fitted using the following Gaussian function after the detection background was deducted. Raman spectrum test conditions: wavelength 532 nm, scan range 200-4000 cm-1, twice accumulations, 10 measurement points for each sample, and fitting performed based on the average value:

$$G ( ν ) = {A}_{i} exp [ - 4 ln ( 2 ) {( \frac{ν - {ν}_{i}}{{w}_{i}} )}^{2} ] .$$

In the above formula, G represented the graphitization degree, and Ai, Vi, and wi represented the peak intensity, peak position, and peak width, respectively.

### (2) Slurry Solid Content

The copper foil was weighed using a weight loss measuring instrument, and the weight was recorded as N0, and tared.

A small amount of the positive electrode active slurry was taken, applied to the copper foil, and weighed using a moisture analyzer, and the weight was recorded as N1. The device was closed for drying, and then the weight was recorded as N2. The solid content was calculated based on (N2−N0)/(N1−N0).

### (3) Slurry Stability Test

After the slurry was re-stirred for 30 min, a certain amount of slurry was poured into a sample bottle of a stability tester, and then the sample bottle was placed. A test tower cover was closed and then opened. A test interface started to display a scanning curve, and the sample stability test began, continuing for more than 72 h to complete the test.

### (4) Coating Cracking Condition

A certain amount of slurry was applied and the coating appearance was observed.

### (5) Brittleness Test

A defect-free positive electrode plate was taken and cut longitudinally into samples of a length*width of 20 cm*2.5 cm, with the number of the samples greater than or equal to eight pieces. They were pre-folded, and film pieces were placed on the test platform and rolled once using a 2 kg cylindrical roller. If light passed through, the brittleness light transmission number was 1 time. If light did not pass through, the reverse folding and rolling were repeated. The crease was observed against the light to check for light transmission or breakage, the number of actual folding times was recorded, and the average was taken as the test result.

### (6) Electrode Plate Resistance

The dried positive electrode slurry (film layer) was cut on the left, middle, and right of the positive electrode plate into small round pieces with a diameter of 3 mm. A power of the electrode-plate resistance meter from Yuan Neng Technology was turned on, the piece was placed in a proper position of a “probe” of the electrode plate resistance meter, the “start” button was clicked, and the shown number was waited to be stable and read. Each small round piece was tested in two positions, and the average of six measurements was calculated as the resistance of the electrode plate film layer.

### (7) First Cycle Coulombic Efficiency

At 25° C., the battery was constant-current charged at a rate of 0.1 C to 4.3 V, and the charging capacity at this time was recorded as the first cycle charge capacity of the secondary battery. Then, the battery was left standing for 5 min, constant-current discharged at 0.1 C to 2.0 V, and left standing for 5 min. This was a charge-discharge cycle, and the discharge capacity at this time was recorded as a first cycle discharge capacity of the secondary battery, that is, the initial capacity of the secondary battery.

The first cycle coulombic efficiency (%) of the secondary battery-first cycle discharge capacity/first cycle charging capacity×100%.

### (8) Cycling Capacity Retention Rate at 45° C.

At 45° C., the battery was constant-current charged at ⅓ C to 3.65 V, constant-voltage charged at 3.65 V to a current of 0.05 C, left standing for 10 min, and discharged at ⅓ C to 2.5 V. The obtained capacity was recorded as an initial capacity C0. The preceding steps were repeated for the same battery and the discharged capacity Cn after the n-th cycle was recorded, and the battery capacity retention rate after each cycle was:

$$Pn = {C}_{n} / {C}_{0} \times 100 \% .$$

In this test, the first cycle corresponds to n=1, the second cycle corresponds to n=2, . . . , and the 100-th cycle corresponds to n=100. The capacity retention rate data corresponding to each example and comparative example in Table 1 were the data measured after 300 cycles under the above test conditions, that is, the value of P300.

It should be noted that in Table 1, the molecular structural formula of A1 was

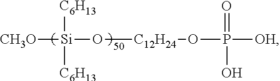

the molecular structural formula of A2 was

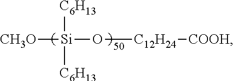

the molecular structural formula of A3 was

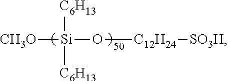

the molecular structural formula of A4 was

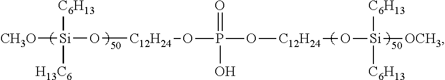

and the molecular structural formula of B1 was

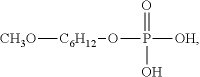

TABLE 1
Relevant parameter test data of each example and each comparative example

| | | | | | | | Electrode | | | |
|---|---|---|---|---|---|---|---|---|---|---|
| | | | | | | | plate | | | |
| | | | | | | | brittleness | | | |
| | | | Percentage of | | | | (the number | | | Capacity |
| | | | a dispersant | | | | of light | | First | retention |
| | | | accounting for | | | | transmission | Electrode | cycle | rate after |
| | LFP | | a total mass of a | Slurry | | Coating | times after | plate | coulombic | 300 cycles |
| | graphitization | Dispersant | positive electrode | Solid | Slurry | cracking | folding) | resistance | efficiency | at 45° C. |
| | degree | composition | active slurry | content | stability | condition | (times) | (Ω) | (%) | (%) |
| Example 1 | 20% | A1 | 0.5 | 66.7% | No | No | 6 | 0.109 | 93.22% | 94.42% |
| | | | | | gelation | cracking | | | | |
| Example 2 | 20% | A1 | 1.5 | 66.2% | No | No | 6 | 0.115 | 93.13% | 93.77% |
| | | | | | gelation | cracking | | | | |
| Example 3 | 20% | A1 | 0.01 | 63.3% | Slight | No | 4 | 0.123 | 90.35% | 90.58% |
| | | | | | gelation | cracking | | | | |
| Example 4 | 20% | A1 | 0.03 | 64.5% | Slight | No | 3 | 0.136 | 91.74% | 91.30% |
| | | | | | gelation | cracking | | | | |
| Example 5 | 20% | A1 | 2 | 64.1% | Slight | No | 3 | 0.132 | 91.49% | 91.81% |
| | | | | | gelation | cracking | | | | |
| Example 6 | 20% | A1 | 3 | 63.0% | Slight | No | 4 | 0.121 | 90.81% | 90.64% |
| | | | | | gelation | cracking | | | | |
| Example 7 | 20% | A2 | 0.5 | 66.4% | No | No | 6 | 0.107 | 93.17% | 93.73% |
| | | | | | gelation | cracking | | | | |
| Example 8 | 20% | A3 | 0.5 | 66.3% | No | No | 6 | 0.109 | 93.28% | 94.17% |
| | | | | | gelation | cracking | | | | |
| Example 9 | 20% | A4 | 0.5 | 66.6% | No | No | 6 | 0.110 | 93.28% | 94.33% |
| | | | | | gelation | cracking | | | | |
| Example 10 | 10% | A1 | 0.5 | 66.2% | No | No | 6 | 0.107 | 93.16% | 93.74% |
| | | | | | gelation | cracking | | | | |
| Example 11 | 30% | A1 | 0.5 | 66.1% | No | No | 6 | 0.113 | 93.29% | 93.81% |
| | | | | | gelation | cracking | | | | |
| Comparative | 20% | / | / | 55.1% | Severe | With | 1 | 0.337 | 85.14% | 85.13% |
| example 1 | | | | | gelation | cracking | | | | |
| Comparative | 20% | B1 | 0.5 | 62.3% | No | No | 1 | 0.138 | 88.55% | 88.83% |
| example 2 | | | | | gelation | cracking | | | | |

Through Examples 1, 10, and 11, it can be known that the dispersant provided in the examples of this application is suitable for various graphitization degrees of positive electrode active materials, meaning it is suitable for positive electrode active materials having different polarities, showing good adaptability. Through comparison between Examples 1-11 and Comparative example 2, it can be known that the dispersant provided in the examples of this application includes a siloxane segment, which increases the folding times corresponding to the brittleness of the electrode plate, enhancing the flexibility of the electrode plate. Using the dispersant of the examples of this application can improve the first cycle coulombic 10 efficiency of the battery and the capacity retention rate after 300 cycles at 45° C. Through comparison between Examples 1-11 and Comparative example 1, it can be known that using the dispersant provided in the examples of this application in the positive electrode active slurry can improve the stability of the slurry, enhance the flexibility of the electrode plate, reduce the resistance of the electrode plate, and improve the first cycle coulombic efficiency of the battery and the capacity retention rate after 300 cycles at 45° C.

The foregoing descriptions are merely implementations of this application, but are not intended to limit the patent scope of this application. Any equivalent structural or equivalent process transformations made by using the content of the specification and drawings of this application, or directly or indirectly used in other related technical fields are included in the patent protection scope of this application in the same way.

What is claimed is:

1. A secondary battery, comprising:
a housing; and
a cell assembly and an electrolyte that are disposed in the housing, wherein the cell assembly comprises a negative electrode plate, a separator, and a positive electrode plate that are sequentially stacked, and the positive electrode plate comprises:
a positive electrode current collector; and
a positive electrode active layer disposed on at least one side of the positive electrode current collector, wherein the positive electrode active layer comprises a positive electrode active material and a dispersant, the dispersant is a polymer comprising an anchoring group and a siloxane segment, and the anchoring group comprises a polar heteroatom-containing group and/or a derivative thereof.

2. The secondary battery according to claim 1, wherein the positive electrode active material comprises a phosphate containing lithium transition metal.

3. The secondary battery according to claim 2, wherein a surface of the phosphate containing lithium transition metal is coated with carbon.

4. The secondary battery according to claim 1, wherein a mass percentage of the dispersant in relation to the positive electrode active material is 0.2%-5%.

5. The secondary battery according to claim 1, wherein:
the polar heteroatom-containing group and/or the derivative thereof comprises at least one of a carboxyl group and a derivative thereof, a sulfonic acid group and a derivative thereof, and a phosphoric acid group and a derivative thereof; and
the carboxyl group and the derivative thereof comprise —O—Cn-COOR₀₁, the sulfonic acid group and the derivative thereof comprise —O—Cn-SO₃R₀₂, and the phosphoric acid group and a derivative thereof comprise 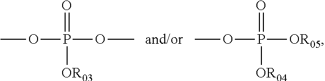
wherein Cn represents an alkane carbon chain, and 1≤n≤12; and R₀₁, R₀₂, R₀₃, R₀₄, and R₀₅ are each independently selected from at least one of H, C1-C12 alkyl, C1-C12 alkyl alcohol, or C1-C12 alkyl hydroxylamine.

6. The secondary battery according to claim 1, wherein the siloxane segment comprises a silicon-oxygen bond and a branched segment connected to a silicon atom, and the branched segment comprises at least one of a C1-C12 carbon chain and a polyether segment.

7. The secondary battery according to claim 1, wherein a structural formula of the dispersant is: 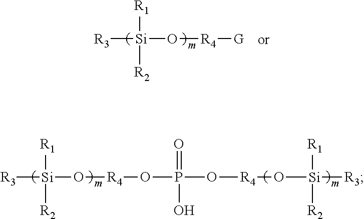
wherein:
G represents the anchoring group;
R₁ and R₂ are each independently selected from at least one of a C1-C12 carbon chain and a polyether segment; and
R₃ and R₄ are each independently selected from at least one of a carbon chain, a polyether segment, a polyester amide segment, an alkoxy segment, 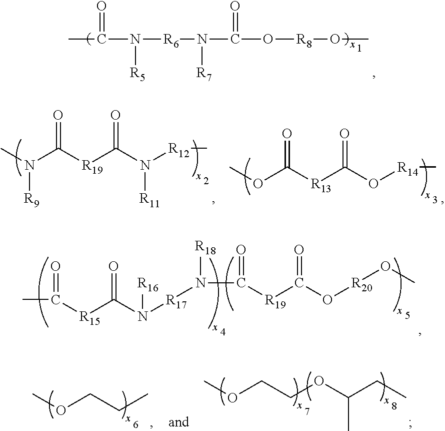
wherein R₅ and R₂₀ are each independently selected from at least one of an alkane carbon chain and a benzene ring; and x₁=1-20, x₂=1-20, x₃=1-20, x₄=1-20, x₅=1-20, x₆=1-40, x₇=1-40, x₈=1-25, and m is 1-100.

8. The secondary battery according to claim 7, wherein at least one of R₃ and R₄ comprises a heteroatom, and the heteroatom comprises at least one of O and N.

9. The secondary battery according to claim 1, wherein a weight average molecular weight of the dispersant is 500 g/mol-50000 g/mol.

10. An electric apparatus, comprising the secondary battery according to claim 1.

11. A preparation method of a secondary battery, comprising:
sequentially stacking a negative electrode plate, a separator, and a positive electrode plate to form a cell assembly, wherein a preparation method of the positive electrode plate comprises: obtaining a positive electrode current collector; and applying a positive electrode active slurry to at least one side of the positive electrode current collector to form a positive electrode active layer; wherein the positive electrode active slurry comprises a positive electrode active material and a dispersant, the dispersant is a polymer comprising an anchoring group and a siloxane segment, and the anchoring group comprises a polar heteroatom-containing group and/or a derivative thereof;
placing the cell assembly in a housing; and
injecting an electrolyte into the housing.

12. The preparation method according to claim 11, wherein:
a solid content of the positive electrode active slurry is greater than or equal to 59%; and/or
a viscosity of the positive electrode active slurry is 4000 mPa·s-30000 mPa·s; and/or
a mass percentage of the dispersant in relation to the positive electrode active material is 0.2%-5%, and the dispersant accounts for 0.01%-3% of a total mass of the positive electrode active slurry.

13. A dispersant, wherein the dispersant is a polymer comprising an anchoring group and a siloxane segment, and the anchoring group comprises a polar heteroatom-containing group and/or a derivative thereof.

14. The dispersant according to claim 13, wherein:
the polar heteroatom-containing group and/or the derivative thereof comprises at least one of a carboxyl group and a derivative thereof, a sulfonic acid group and a derivative thereof, and a phosphoric acid group and a derivative thereof; and
the carboxyl group and the derivative thereof comprise —O—Cn-COOR₀₁, the sulfonic acid group and the derivative thereof comprise —O—Cn-SO₃R₀₂, and the phosphoric acid group and a derivative thereof comprise 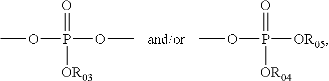
wherein Cn represents an alkane carbon chain, and 1≤n≤12; and R₀₁, R₀₂, R₀₃, R₀₄, and R₀₅ are each independently selected from at least one of H, C1-C12 alkyl, C1-C12 alkyl alcohol, or C1-C12 alkyl hydroxylamine.

15. The dispersant according to claim 13, wherein the siloxane segment comprises a silicon-oxygen bond and a branched segment connected to a silicon atom, and the branched segment comprises at least one of a C1-C12 carbon chain and a polyether segment.

16. The dispersant according to claim 13, wherein a structural formula of the dispersant is: 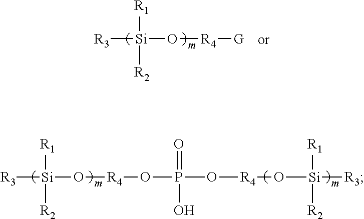
wherein:
G represents the anchoring group;
R₁ and R₂ are each independently selected from at least one of a C1-C12 carbon chain and a polyether segment; and
R₃ and R₄ are each independently selected from at least one of a carbon chain, a polyether segment, a polyester amide segment, an alkoxy segment, 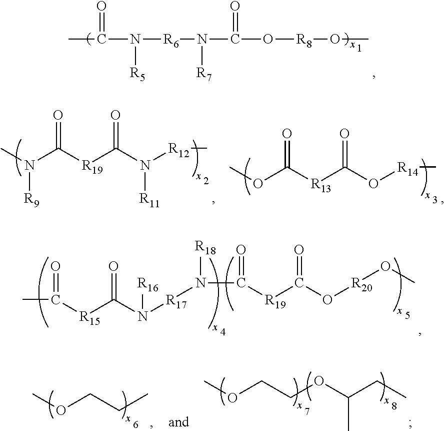
wherein R₅ and R₂₀ are each independently selected from at least one of an alkane carbon chain and a benzene ring; and x₁=1-20, x₂=1-20, x₃=1-20, x₄=1-20, x₅=1-20, x₆=1-40, x₇=1-40, x₈=1-25, and m is 1-100.

17. The dispersant according to claim 16, wherein at least one of R₃ and R₄ comprises a heteroatom, and the heteroatom comprises at least one of O and N.

18. The dispersant according to claim 13, wherein a weight average molecular weight of the dispersant is 500 g/mol-50000 g/mol.
